(19) United States
(12) Patent Application Publication
(10) Pub. No.: US 2025/0001789 A1
(43) Pub. Date: Jan. 2, 2025

(54) A METHOD FOR THE PRODUCTION OF A MATTE MULTILAYER SURFACE WITH AN INCREASED HAPTIC EFFECT AND A MULTILAYER SURFACE

(71) Applicant: SCHATTDECOR SP. Z.O.O., Tarnowo Podgórne (PL)

(72) Inventors: Jerzy SZEJWIAN, Tarnowo Podgórne (PL); Michal SMUS, Tarnowo Podgórne (PL); Krzysztof KONIECZNY, Tarnowo Podgórne (PL); Mateusz NOWAK, Tarnowo Podgórne (PL)

(21) Appl. No.: 18/709,504

(22) PCT Filed: Nov. 13, 2022
(86) PCT No.: PCT/PL2022/050078

§ 371 Date: May 12, 2024

(30) Foreign Application Priority Data
Nov. 15, 2021 (PL) P.439497

(51) Int. Cl. B41M 7/00; B41M 1/04; B41M 1/10; B41M 1/26; B41M 3/00; B41M 5/00; C09D 11/101; C09D 11/108

(52) U.S. Cl. CPC B41M 7/0045; B41M 1/04; B41M 1/10; B41M 1/26; B41M 3/008; B41M 5/0064; B41M 7/0036; C09D 11/101; C09D 11/108

(57) ABSTRACT

The invention relates to a method for the production of a matte multilayer coated surface with an increased haptic effect and a substrate with decorations in the form of wooden, stone or fancy motifs, characterized in that the topcoat electron curable varnish layer (4) is exposed to an excimer lamp and electron beam radiation and the structural electron curable varnish layer (5) is successively applied, exposed to an LED lamp emitting UV radiation with a wavelength of 395 nm or a PAC lamp with a wavelength of 254 nm and to an excimer lamp. The combined layers are cured by an electron beam with a minimum dose of 40 kGy. The invention also relates to a surface obtained by this method. The surface, according to the invention, is used as an outer layer of furniture boards.

The subject of the invention is a method for the production of a matte multilayer surface with an increased haptic effect, on carriers such as paper or plastic foils, in particular BOPP, CPP, PVC, PET. The subject of the invention is also a multilayer surface obtained by such a method and a furniture article comprising a matte multilayer surface according to the present invention.

The invention can be applied for the production of furniture surfaces. It can also be used to provide structure in the production of melamine surfaces.

Known are concave three-dimensional coated surfaces, whose structure is printed for example by means of a special paint with anti-adhesive properties and convex surfaces, in which the overprint of the structure is obtained with paint with extenders or varnish. Another division divides surfaces into synchronous surfaces, in which the three-dimensional structure reflects the elements of the print pattern, and asynchronous, in which the three-dimensional structure does not reflect the print pattern.

For practical reasons and in view of the aesthetic preferences of the consumers, furniture manufacturers use boards with a matte finish for the furniture production. The currently known technologies allow to obtain a matte finish on coated surfaces by using coatings, both water-based and EB (the polymerisation of the coating is activated by an electron beam) as well as UV (the polymerisation of the coating is activated by ultraviolet light) coatings with matting agents.

An example for such finishes are the products of the company Schattdecor: even surfaces Smartfoil, three-dimensional concave surfaces Smartfoil Real and three-dimensional convex surfaces Smartfoil Evo and Smartfoil 3D. Matting agents have a negative impact on the rheological properties of coating and complicate the coating process, especially by depositing on the applicator devices, e.g. paint rollers. The application of matting agents in coatings used for printing three-dimensional structures also limits the possibility to obtain structures with a highly diversified screen ruling due to the large size of the matting particles. In practice it is very difficult to achieve the chemical and mechanical standard for furniture foils with a gloss level of below 10° (when measured in a 60° geometry).

A method is also known to obtain a gloss level of under 10° on the surface by exposing special types of varnishes to an excimer lamp emitting light with a wavelength of 172 nm. UV excimer lamps operating at a wavelength of 172 nm cause the gelation effect of the top layer of varnish, which results in the creation of a microstructure giving a deep matte optical effect. These surfaces are then fully cured, i.e. full cross-linking is achieved by treating the surfaces with UV radiation of a longer wavelength or with an electron beam with a defined dose. This method, however, allows to obtain only an even, single-layer surface.

Patent specification U.S. Pat. No. 236,233B1 discloses a method of surface treatment with an excimer lamp in order to obtain the matte effect. This method discloses the use of an adhesion enhancing additive and gelation of the layer if a subsequent layer has been applied thereon. This allows to obtain multilayer three-dimensional surfaces, maintaining the quality required for the furniture industry, with a thickness in the range of 3 to 20 μm. The most desirable effects of surface matting with excimer lamps are obtained in the range of applied coatings or structures with a thickness of 5 to 20 μm. This thickness allows the stability of the applied layer to be maintained.

However, studies have shown that the application of multiple layers, which are then matted with excimer lamps, with a total thickness of more than 20 μm, results in certain defects that are unacceptable in the design of decorative surfaces, such as pinhead highlights on the surface of the pore, but of a smaller size. Sometimes there are several highlights on the surface of one pore. The reason for such defects is excessive local application of varnish. Immediately after exposure to excimer lamps, the structure may collapse or behave in an uncontrolled manner due to these defects. Since the excimer affects only 0.1-0.5 nm of the outer layer of the varnish top layer, the coating in the remaining range is unstable, which causes partial exposure of the bottom layer, which then becomes visible in the form of highlights on the surface.

The purpose of the present invention is to develop a method for producing a multilayer matte surface with the effect of a three-dimensional structure, with a thickness exceeding 20 μm, with a very clear haptic effect, characterized by a matte finish.

The present invention achieves this by pre-stabilizing the electron curable varnish layer, which for the purposes of the present invention is referred to as a pore layer, i.e. slightly gelling through the entire thickness just prior to the excimer treatment.

This is achieved by treating the applied electron curable varnish layer with UV radiation with a wavelength of 254 (PAC lamp) or 395 nm (LED lamp), with each previously applied layer being pre-polymerized with an electron beam with a generator power of 2-7 kGy, which causes varnish pre-polymerization. This treatment allows to obtain stable coating structures with a total thickness in the range of 20 μm-30 μm, which structures are matted in the next stage by the action of excimer rays. This effect of slight gelling of the structure, before matting the structure, is primarily to guarantee the constant height and stability of each of the pores applied with the cylinder.

It turned out that exposing the last applied electron curable varnish layer to light with a wavelength of 254 (PAC lamp) or 395 nm (LED lamp) allows to obtain a layer with a thickness of 20-30 μm, when the previously applied electron curable varnish layers are slightly gelled, matted with an excimer and all electron curable varnish layers are finally cured.

For the purposes of this invention, it should be assumed that when mentioning the layers referred to as the electron curable varnish layer (4, 6), they mean layers that enable pre-polymerization (gelling) by exposing them to the action of an electron beam generator with a low dose in the range of 2-7 kGy or an adequate dose of UV radiation. At the same time, the layers named in this way sometimes refer to already finished polymerized and/or cured surfaces/structures.

The essence of the present invention is a method of producing a multilayer coated matte surface, which can later be used for the production of decorative materials in the furniture industry. Possible surfaces are substrates with decorations in the form of wooden, stone or fantasy motifs.

The method according to the present invention comprises the following steps:
a) providing the carrier layer (1),
b) applying the protective layer (3),
c) drying the protective layer (3),
d) applying the topcoat electron curable varnish layer (4),
e) exposing the layer obtained in step d) to an excimer lamp emitting radiation with a wavelength of 172 nm,
f) exposing the surface obtained in step e) to electron beam radiation with a dose in the range of 2-7 kGy,
g) applying the subsequent structural electron curable varnish layer (5),
h) exposing the layer obtained in step g) to an LED lamp emitting UV radiation with a wavelength of 395 nm or a PAC lamp with a wavelength of 254 nm;
i) exposing the structure obtained in step h) to an excimer lamp emitting radiation with a wavelength of 172 nm,
j) exposing the structure obtained in step i) to electron beam radiation with a minimum dose of 40 kGy and complete curing of all varnish layers.

It is beneficial if between applying the topcoat electron curable varnish layer (4) formed in steps d),e),f), before applying the subsequent structural electron curable varnish layer (5) applied in step g), the method according to the present invention comprises the steps below:
f1) applying at least one subsequent structural electron curable varnish layer (6),
f2) exposing the layer obtained in step f1) to an excimer lamp emitting radiation with a wavelength of 172 nm,
f3) exposing the structure obtained in step f2) to electron beam radiation with a dose in the range of 2-7 kGy,

It is beneficial if the decorative layer (2), which is printed in rotogravure printing, flexographic printing or digital printing process, is applied to the carrier layer (1). In rotogravure printing according to the present invention, the method of transferring the print or varnish to the carrier layer (1) consists in pressing it with a special roller coated with a layer of rubber of appropriate hardness to the printing cylinder. The cylinder is immersed in a rotating toner container with a feed roller. Excess paint is removed by means of an adjustable scraper blade on the printing cylinder.

When the decorative layer (2) is applied to the carrier layer (1), the structural electron curable varnish layer (5) can be applied in a way that matches the imprinted design. The structural electron curable varnish layer (5) may be synchronous with the individual decorative elements or it may be asynchronous.

The essence of the invention is also a multilayer matte surface with an increased haptic effect, consisting of:
a) the carrier layer made of paper-based material or polymer film,
b) the protective layer (3),
c) the topcoat electron curable varnish layer (4) with a thickness of 5-9 μm, applied over the entire width of the carrier 1, in which the varnish is matted with an excimer lamp emitting radiation with a wavelength of 172 nm,
d) the structural electron curable varnish layer EB (5) with a thickness of 20-30 μm, matted with an excimer lamp emitting radiation with a wavelength of 172 nm,
   where the varnished layers are finally, fully cured with an electron beam with a minimum dose of 40 kGy,
   characterized in that the last layer, which is the structural electron curable varnish layer (5) is pre-gelled by irradiating the varnish with a LED lamp emitting UV radiation with a wavelength of 395 nm or a PAC lamp with a wavelength of 254 nm.

It is beneficial if the multilayer surface according to the invention, on the topcoat electron curable varnish layer (4) formed in step c), contains at least one subsequent structural electron curable varnish layer (6) pre-matted with radiation from an excimer lamp with a wavelength of 172 nm.

It is beneficial if the carrier layer (1) comprises the decorative layer (2).

It is beneficial if the carrier layer (1) mentioned in step a) is in the form of a film made of a natural material, such as paper, or made of an artificial material, such as biaxially oriented polypropylene (BOPP), cast polypropylene (CPP), polyvinyl chloride (PVC) or polyethylene terephthalate (PET). The carrier layer 1 can also be made of a wood-based panel.

It is also beneficial if the protective layer (3), applied in step
b), is a mixture based on acrylates, improving chemical resistance, applied with an intaglio cylinder.

It is also beneficial if the electron curable varnish layer EB (4, 5, 6) contains an additive increasing the bond strength of the varnish, selected from the group of additives created on the basis of micronised wax based on very sensitive polyethylenes with the addition of propoxylated glycerol triacrylate.

The topcoat electron curable varnish layer (4) is made of varnishes available in the prior art. It contains FLE 27800 varnish. This varnish is also a component forming the structural electron curable varnish layer (6).

To obtain a matte effect, the layer (4, 6) is first exposed to an excimer lamp emitting light with a wavelength of 172 nm. This procedure does not completely cure the varnish layer (4, 6), only its surface is slightly cross-linked, causing a matt appearance on the surface. After the treatment with an excimer lamp, the varnish coating is a surface with a topography that makes it difficult to bond with the next layer. For this reason, an additive increasing the bond strength, preferably such as FZ 2720, is used in both varnish layers as well as gelling of the layers is carried out. The excimer-treated topcoat electron curable varnish layer (4) then moves to the electron beam generator and is exposed to an electron beam with a dose in the range of 2-7 kGy. This dose does not ensure full cross-linking and is not sufficient to complete the polymerization. This allows for another layer to be applied on top as the topcoat layer is not fully cured. The thickness of the topcoat layer (4) is 5-9 μm.

The structural electron curable varnish layer (5) is made of varnishes available in the prior art. The layer (5) is first subjected to the stabilization process described in step h), by exposure to a lamp emitting UV light with a wavelength of 254 nm in the case of a PAC lamp and 395 nm in the case of an LED lamp. This wavelength is necessary to obtain the desired degree of polymerization, taking into account the thickness of the applied layer, i.e. 20-30 μm. The structural electron curable varnish layer (5) is slightly polymerized, without disturbing its surface, only a technical effect is obtained that improves the stiffness of the next layer, thanks to which constant thickness and stability of each of the pores applied with a cylinder are ensured. To obtain a matte effect, as in the case of the topcoat electron curable varnish layer (4), the structural electron curable varnish layer (5) is exposed to an excimer lamp emitting light with a wavelength of 172 nm. This procedure does not completely cure the structural electron curable varnish layer (5), only its surface is slightly disturbed, causing a matt appearance on the surface. The excimer-treated structural electron curable varnish layer (5) then moves to the electron beam generator and is exposed to an electron beam with a minimum dose of 40 kGy. This dose is necessary to complete the polymerization of the layer (4) and complete the curing of the structural electron curable varnish layer (5).

In one embodiment, the carrier layer (1) is provided with the decorative layer (2) imitating a wood grain pattern. Before applying the second radiation curable structural electron curable varnish layer (5) in step g), the method according to the present invention, with the effect in the form of the coating shown in FIG. 6, may further include the steps below:
f1) applying the subsequent structural electron curable varnish layer (6),
f2) exposing the structure obtained in step f1) to an excimer lamp emitting radiation with a wavelength of 172 nm,
f3) exposing the structure obtained in step f2) to electron beam radiation with a dose of 4 kGy (2-7 kGy).
   The subsequent structural electron curable varnish layer (6) is made of varnishes available in the prior art. The excimer treatment used in step f2) does not completely cure the subsequent structural electron curable varnish layer (6), the surface is slightly disturbed causing the surface to look matte, the second structural electron curable varnish layer (6) then moves to the electron beam generator and is exposed to an electron beam with a dose of 4 kGy (2-7 kGy). This dose does not ensure full cross-linking and is not sufficient to complete the polymerization. This allows more layers to be applied on top as the layer is not fully cured. It will then be possible to apply another layer of electron curable varnish on the surface, for example the structural electron curable varnish layer (5).

The advantage of PAC or LED lamps is that they are compact devices with dimensions much smaller than the electron beam generator, while maintaining good production efficiency parameters. At the same time, they allow gelation of the structure (porous varnish) with increased thickness, which avoids the aforementioned highlight defects on the surface of the pores.

### EXAMPLE 1—POSITIVE MOULD, SYNCHRONOUS EFFECT

The foil production process is based on the use of a printing and varnishing machine.

The wood-like design patter forming the decorative layer 2 is applied onto the carrier 1 which is made of paper film. The design is transferred onto the band by pressing it with a special roller coated with rubber of adequate hardness to the printing cylinder. The cylinder is immersed in a rotating toner container with a feed roller. Excess ink is removed by means of an adjustable scraper blade on the printing cylinder. The band with the applied ink is then dried in a hot air chamber and afterwards transported to the next printing unit. The carrier passes through three printing stations. Water-soluble inks are used in this process.

Each of the printing stations has a drying chamber where, at a temperature between 50°-150° C., the applied ink is cured on the carrier.

The next step is to coat the printed carrier 1 with a protective layer 3. This is achieved by means of a unit with a special intaglio cylinder for the application of the primer 20-97.10. The cylinder applies about 6 g/m² of the primer which, like the ink, is cured in a gas dryer at a temperature of 140 C until the water evaporates from the applied primer, keeping the dry weight of the dispersion on the band.

Then the structure is coated with the first layer of the electron curable varnish 4 in the 3WS coating system. The Hesse varnish used has the following composition:
FL 27692—0.9 part
FLE 27800—0.1 part
FZ 2711—0.07 part
FZ 2720—0.15 part
Photoinitiator UZ 7381—0.01 part

The obtained coating 4 with a grammage of 8 g/m₂ is exposed to an excimer lamp emitting radiation with a wavelength of 172 nm, which causes the coating to become matte. Then the layer 4 is subjected to the pre-polymerization (gelation) process in the electron beam generator. The generator parameter settings are as follows:
Dose 2 kGy
100 kV high voltage.

The resulting surface has a gloss level of 5° when measured in a 60° geometry.

Then the carrier band advances to the intaglio cylinder station with a synchronous pattern for individual elements of the main design of the decorative layer 2.

The second structural electron curable varnish layer 5 is applied, and the varnish has the following composition:
FLE 27800—1 part
FZ2720—0.15 parts
Photoinitiator Omnirad TPO-L—0.005 part
Photoinitiator UZ 7381—0.01 part

The surface is stabilized under the action of UV rays with a wavelength of 395 nm using an LED lamp. The surface is then exposed to an excimer lamp emitting radiation with a wavelength of 172 nm. This treatment is followed by the final curing in the generator in the area of the entire thickness of all varnish layers. The generator parameters are as follows:
dose 40 kGy
110 KV high voltage.

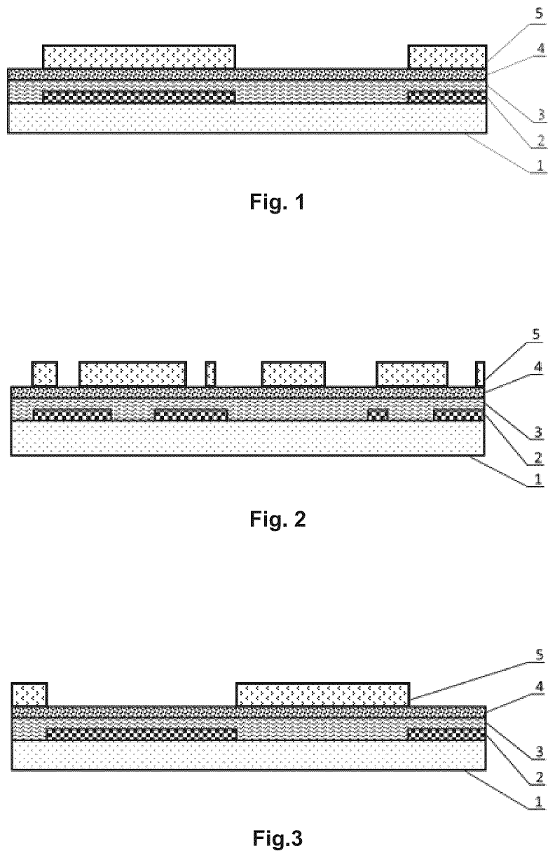

The multilayer surface, the cross-section of which is shown in FIG. 1, in addition to the visual effect of the imprinted design, also gives a tactile feel. The applied 27 μm-thick porous structure correlating with the individual elements of the main design has a gloss level of 1°-2° measured in a 60° geometry.

### EXAMPLE 2—POSITIVE MOULD, ASYNCHRONOUS EFFECT

The decorative layer 2 is applied to the carrier 1 in the form of a plastic film band in the same manner as described in Example 1. The printed carrier 1 is then coated with the protective layer 3, which is Primer FG 2810. This coating is carried out using an intaglio cylinder, which applies approx. 5 g/m² of the primer. This layer is cured in a dryer at a temperature of 75° C.

Then the structure is coated with the first layer of the topcoat electron curable varnish 4 using the 3WS coating system. The varnish used at this step has the following composition:
FL 27694—0.8 part
FLE 27800—0.2 part
FZ 2711—0.07 part
FZ 2720—0.15 part
Photoinitiator UZ 7381—0.01 part

The obtained coating of the topcoat electron curable varnish layer 4 with a grammage of 8 g/m² is exposed to an excimer lamp emitting radiation with a wavelength of 172 nm, which causes the coating to become matte. Then the layer 4 is subjected to the pre-polymerization (gelation) process in the electron beam generator. The generator parameter settings are as follows:
Dose 2 kGy
100 kV high voltage.

The resulting surface has a gloss level of 7° when measured in a 60° geometry. The coated band then advances to the intaglio cylinder station with a pattern that is asynchronous with the individual main decorative elements (decorative layer 2). At this step, the structural electron curable varnish layer 5 is applied, and the varnish has the following composition:
FLE 27800—1 part
FZ 2720—0.15 part
Photoinitiator Omnirad 819—0.005 part
Photoinitiator UZ 7381—0.01 part

The structural coating formed by electron curable varnish (5) is stabilized under the action of UV rays with a wavelength of 254 nm using a PAC lamp The surface is then exposed to an excimer lamp emitting radiation with a wavelength of 172 nm. This treatment is followed by the final curing in the electron beam generator in the area of the entire thickness of all varnish layers. The generator parameters are as follows:
Dose 40 kGy
110 KV high voltage.

The multilayer surface, the cross-section of which is shown in FIG. 2, in addition to the visual effect of the imprinted design, also gives a tactile feel.

The applied 22 μm-thick asynchronous porous structure, which does not correlate with the individual elements of the main design, has a gloss level of 1°-2° measured in a 60° geometry.

### EXAMPLE 3—NEGATIVE MOULD, SYNCHRONOUS EFFECT

The decorative layer 2 and the protective layer 3 are applied to the carrier layer 1 as described in Example 1.

The next step is to apply the topcoat electron curable varnish layer 4 in the 3WS coating system. The varnish used at this step has the following composition:
FLE 27800—1 part
FZ 2720—0.15 part
Photoinitiator UZ 7381—0.02 part

The obtained coating of the topcoat electron curable varnish layer 4 with a grammage of 8 g/m₂ is exposed to an excimer lamp emitting radiation with a wavelength of 172 nm, which causes the coating to become matte. Then the layer 4 is subjected to the pre-polymerization (gelation) process in the electron beam generator. The generator settings are as follows:
Dose 2 kGy
100 kV high voltage.

The resulting surface has a gloss level between 1° and 2° when measured in a 60° geometry.

The next step in the production process according to the invention is to apply the structural electron curable varnish layer 5, which is synchronous with each part of the design, as shown in FIG. 3. A structure is applied whose varnish has the following composition:
FL 27694—0.9 part
FLE 27800—0.1 part
FZ 2711—0.07 part
FZ 2720—0.15 part
Photoinitiator Omnirad 2022—0.005 part
Photoinitiator UZ 7381—0.01 part

The surface is stabilized under the action of UV rays with a wavelength of 395 nm using an LED lamp. The surface is then exposed to an excimer lamp emitting radiation with a wavelength of 172 nm. This treatment is followed by the final curing in the electron beam generator in the entire thickness of all varnish layers. The generator parameters are as follows:
Dose 40 kGy
110 KV high voltage.

The multilayer structure, the cross-section of which is shown in FIG. 3, in addition to the visual effect of the imprinted design, also gives a tactile feel.

The layer of cured varnish applied with a negative intaglio cylinder has a thickness of 25 μm, gloss level of 8° measured in a 60° geometry.

### EXAMPLE 4—OFF-LINE VARNISHING, ASYNCHRONOUS NEGATIVE MOULD

The decorative layer 2 and the protective layer 3 are applied to the carrier layer 1 as described in Example 1.

In the next technological cycle, the topcoat electron curable varnish layer 4 is applied with the 3WS coating system. The varnish used has the following composition:
FLE 27800—1.0 part
FZ 2720—0.1 part
Photoinitiator UZ 7381—0.01 part

The obtained coating of the topcoat electron curable varnish layer 4 with a grammage of 8 g/m₂ is exposed to an excimer lamp emitting radiation with a wavelength of 172 nm, which causes the coating to become matte. Then the topcoat electron curable varnish layer 4 is subjected to the pre-polymerization (gelation) process in the electron beam generator. The generator settings are as follows:
Dose 3 kGy
100 kV high voltage.

The obtained surface has a gloss level between 1° and 2° measured in a 60° geometry.

The semi-finished product prepared in this way is rolled up on a roll and is ready for the next processing step.

In the next off-line technological cycle the asynchronous structural electron curable varnish layer 5 is applied to the individual elements of the wood-like design at another varnishing machine.

At this step of the process, the varnish has the following composition:
FL 27692—0.9 part
FLE 27800—0.1 part
FZ 2711—0.07 part
FZ 2720—0.2 part
Photoinitiator Omnirad 2100—0.005 part
Photoinitiator UZ 7381—0.01 part

The surface of the structural electron curable varnish layer 5 is stabilized under the action of UV rays with a wavelength of 395 nm using an LED lamp. The surface is then exposed to an excimer lamp emitting radiation with a wavelength of 172 nm. This treatment is followed by the final curing in the electron beam generator in the area of the entire thickness of all varnish layers. The generator parameters are as follows:
Dose 40 kGy
110 KV high voltage.

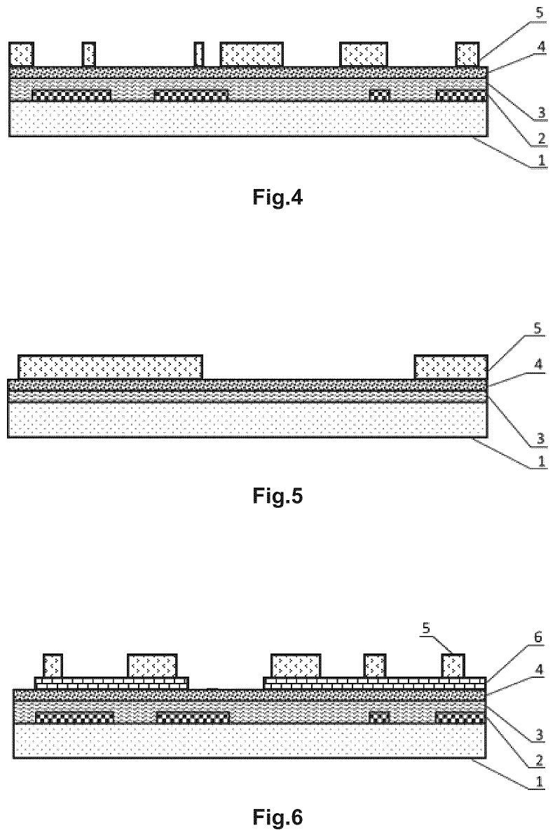

The layer of cured varnish, the cross-section of which is shown in FIG. 4, in addition to the visual effect of the imprinted design, also gives a tactile feel.

The layer of cured varnish applied with a negative intaglio cylinder has a thickness of 29 μm, gloss level of 6° measured in a 60° geometry.

### EXAMPLE 5—VARNISHING WITHOUT PRINT ON THE CARRIER

The protective layer 3 is applied directly to the carrier layer 1, i.e. paper without any decorative imprinted design, in the same manner as shown in Example 1.

Then, over the entire band width, the topcoat electron curable varnish layer 4 is applied using the 3WS varnishing system. At this step of the process, the varnish used has the following composition:
FL 27694—0.9 part
FLE 27800—0.1 part
FZ 2711—0.07 part
FZ 2720—0.15 part
Photoinitiator UZ 7381—0.01 part

The obtained topcoat electron curable varnish layer 4 with a grammage of 8 g/m₂ is exposed to an excimer lamp emitting radiation with a wavelength of 172 nm, which causes the coating to become matte. Then the layer 4 is subjected to the pre-polymerization (gelation) process in the electron beam generator. The generator settings are as follows:
Dose 2 kGy
100 kV high voltage.

The obtained surface has a gloss level of 8° measured in a 60° geometry.

The carrier band then advances to the intaglio cylinder station. The second structural electron curable varnish layer 5 is applied, and the varnish has the following composition:
FLE 27800—1 part
FZ 2720—0.15 part
Photoinitiator Omnirad TPO-L—0.005 part
Photoinitiator UZ 7381—0.01 part

The surface of the structural electron curable varnish layer 5 is stabilized under the action of UV rays with a wavelength of 254 nm using a PAC lamp. The structure is then exposed to an excimer lamp emitting radiation with a wavelength of 172 nm. This treatment is followed by the final curing in the electron beam generator in the area of the entire thickness of all varnish layers. The generator parameters are as follows:
Dose 40 kGy
110 KV high voltage.

The 23 μm-thick multilayer “porous” structure, the cross section of which is shown in FIG. 5, has a tactile feel and a gloss level of 1°-2° measured in a 60° geometry.

### EXAMPLE 6—OFF-LINE VARNISHING, POSITIVE MOULD, ASYNCHRONOUS EFFECT, 3 LAYERS OF ELECTRON CURABLE VARNISH

The decorative layer 2 and the protective layer 3 are applied to the carrier layer 1 as described in Example 1.

In the next technological cycle, the first topcoat electron curable varnish layer 4 is applied with the 3WS coating system. The varnish used has the following composition:
FL 27692—0.8 part
FLE 27800—0.2 part
FZ 2711—0.07 part
FZ 2720—0.15 part
Photoinitiator UZ 7381—0.02 part

The obtained topcoat electron curable varnish layer 4 with a grammage of 8 g/m₂ is exposed to an excimer lamp emitting radiation with a wavelength of 172 nm, which causes the coating to become matte. Then the layer 4 is subjected to the pre-polymerization (gelation) process in the electron beam generator. The generator settings are as follows:
Dose 2 kGy
100 kV high voltage.

The obtained surface has a gloss level of 3° measured in a 60° geometry.

The band then advances to the intaglio cylinder station with a pattern that is asynchronous with the individual main decorative elements formed in the decorative layer 2. The structural electron curable varnish layer 6 is applied, and the varnish has the following composition:
FLE 27692—0.9 part
FLE 27800—0.1 part
FZ 2720—0.15 part
Photoinitiator UZ 7381—0.01 part

The surface is exposed to an excimer lamp emitting radiation with a wavelength of 172 nm, which causes the surface to become matte. Then the structural electron curable varnish layer 6 is subjected to the pre-polymerization (gelation) process in the electron beam generator. The generator parameter settings are as follows:
Dose 3 kGy
100 kV high voltage.

After this step, a decorative structure with a thickness of 4 μm and a gloss level of 5° is obtained, measured in a 60° geometry.

In the next off-line technological cycle the next structural electron curable varnish layer EB 5 is applied. The layer is applied with an intaglio cylinder with a greater depth of engraving than in the electron curable varnish layer 6 application step. The varnish composition in this part of the process is as follows:
FLE 27800—1 part
FZ 2720—0.15 part
Photoinitiator Omnirad 819—0.005 part
Photoinitiator UZ 7381—0.01 part

Subsequently, the surface is stabilized under the action of UV rays with a wavelength of 395 nm using an LED lamp. The surface is then exposed to an excimer lamp emitting radiation with a wavelength of 172 nm. This treatment is followed by the final curing in the electron beam generator in the area of the entire thickness of all varnish layers. The generator parameters are as follows:
Dose 40 kGy
110 KV high voltage.

The obtained surface, the cross-section of which is shown in FIG. 6, in addition to the visual effect of the imprinted design, also gives a tactile feel. The total thickness of the structural electron curable varnish layer 5 is 30 μm, and the surface has a gloss level of 1°-2° measured in a 60° geometry.

In all variants of the invention presented in the above examples, the varnish mixture in both application units contains a special additive improving the bond strength between the individual layers. The additional condition for achieving good bond strength is that each layer of varnish is subjected to pre-polymerization (gelation) at the stage of producing a matte surface preceding the last layer.

1. A method for the production of a matte multilayer coated surface with an increased haptic effect and a substrate with decorations in the form of wooden, stone or fancy motifs, characterized in that it comprises the following steps:
a) providing the carrier layer (1),
b) applying the protective layer (3),
c) drying the protective layer (3),
d) applying the topcoat electron curable varnish layer (4),
e) exposing the layer obtained in step d) to an excimer lamp emitting radiation with a wavelength of 172 nm,
f) exposing the surface obtained in step e) to electron beam radiation with a dose in the range of 2-7 kGy,
g) applying the subsequent structural electron curable varnish layer (5),
h) exposing the layer obtained in step g) to an LED lamp emitting UV radiation with a wavelength of 395 nm or a PAC lamp with a wavelength of 254 nm;
i) exposing the structure obtained in step h) to an excimer lamp emitting radiation with a wavelength of 172 nm,
j) exposing the structure obtained in step i) to electron beam radiation with a minimum dose of 40 kGy and complete curing of all layers.

2. The method according to claim 1, characterized in that after applying the topcoat electron curable varnish layer (4) formed in steps d), e), f), before applying the subsequent structural electron curable varnish layer (5) applied in step g), the steps below are carried out:
f1) applying at least one subsequent structural electron curable varnish layer (6),
f2) exposing the layer obtained in step f1) to an excimer lamp emitting radiation with a wavelength of 172 nm,
f3) exposing the structure obtained in step f2) to electron beam radiation with a dose in the range of 2-7 kGy.

3. The method according to claim 1 characterized in that the decorative layer (2), which is printed in rotogravure printing, flexographic printing or digital printing process, is applied to the carrier layer (1).

4. The method according to claim 3, characterized in that the structural electron curable varnish layer (5) is applied in a manner that matches the imprinted design, synchronously with individual decorative elements or asynchronously.

5. A multilayer matte surface with an increased haptic effect, consisting of:
a) the carrier layer made of paper-based material or polymer film,
b) the protective layer (3),
c) the topcoat electron curable varnish layer (4) with a thickness of 5-9 μm, applied over the entire width of the carrier 1, in which the varnish is matted with an excimer lamp emitting radiation with a wavelength of 172 nm,
d) the structural electron curable varnish layer EB (5) with a thickness of 20-30 μm, matted with an excimer lamp emitting radiation with a wavelength of 172 nm,
where the varnished layers are finally, fully cured with an electron beam with a minimum dose of 40 kGy,
characterized in that the last layer, which is the structural electron curable varnish layer (5) is pre-gelled by irradiating the varnish with a LED lamp emitting UV radiation with a wavelength of 395 nm or a PAC lamp with a wavelength of 254 nm.

6. The multilayer surface according to claim 5, characterized in that on the topcoat electron curable varnish layer (4) formed in step c), there is at least one subsequent structural electron curable varnish layer (6) pre-matted with radiation from an excimer lamp with a wavelength of 172 nm.

7. The multilayer surface according to claim 5 characterized in that the carrier layer (1) comprises the decorative layer (2).

8. The multilayer surface according to claim 5 characterized in that the carrier layer (1) mentioned in step a) is in the form of a film made of a natural material, such as paper or wood-based board, or made of an artificial material, such as biaxially oriented polypropylene (BOPP) or cast polypropylene (CPP) or polyvinyl chloride (PVC) or polyethylene terephthalate (PET).

9. The multilayer surface according to claim 5 characterized in that the protective layer (3), applied in step b), is a mixture based on acrylates, improving chemical resistance, applied with an intaglio cylinder.

10. The multilayer surface according to claim 5 characterized in that the electron curable varnish layer (4, 5, 6) contains an additive increasing the bond strength of the varnish, selected from the group of additives created on the basis of micronised wax based on very sensitive polyethylenes with the addition of propoxylated glycerol triacrylate.
